(19) United States
(12) Patent Application Publication
(10) Pub. No.: US 2026/0004236 A1
(43) Pub. Date: Jan. 1, 2026

(54) METHOD FOR VISUALIZATION AND GENERATION OF A VIRTUAL ENVIRONMENT OF A STORE

(71) Applicant: Simbe Robotics, Inc., Burlingame, CA (US)

(72) Inventors: Bradley Bogolea, Burlingame, CA (US); Jariullah Safi, Burlingame, CA (US); Kanchan Bahirat, Burlingame, CA (US)

(21) Appl. No.: 19/252,938

(22) Filed: Jun. 27, 2025

Related U.S. Application Data
(60) Provisional application No. 63/664,945, filed on Jun. 27, 2024.

(51) Int. Cl. G06Q 10/087; G06T 19/00; G06V 10/75; G06V 40/10

(52) U.S. Cl. CPC G06Q 10/087; G06T 19/006; G06V 10/751; G06V 40/103

(57) ABSTRACT

One variation of a method includes: accessing a sequence of images of an inventory structure captured by a mobile robotic system during a scan cycle within a facility; detecting a set of features, representing a product descriptor, proximal a slot in an image in the sequence of images; retrieving a set of template features of a product type associated with the product descriptor from a database of template features; detecting absence of product units of the product type in the slot based on absence of features analogous to the set of template features in the image; constructing a three-dimensional image of the inventory structure based on the sequence of images; annotating the three-dimensional image with a marker representing absence of product units of the product type in the slot; and serving the three-dimensional image of the inventory structure to a portal accessed by an associate affiliated with the facility.

### CROSS-REFERENCE TO RELATED APPLICATIONS

This application claims the benefit of U.S. Provisional Application No. 63/664,945, filed on 27 Jun. 2024, which is incorporated in its entirety by this reference.

### TECHNICAL FIELD

This invention relates generally to the field of stock tracking and, more specifically, to a new and useful method for visualization and generation of a virtual environment of a store in the field of stock tracking.

### BRIEF DESCRIPTION OF THE FIGURES

FIG. 1 is a flowchart representation of a method;

FIG. 2 is a flowchart representation of one variation of the method;

FIGS. 3A and 3B are flowchart representations of one variation of the method;

FIG. 4 is a flowchart representation of one variation of the method; and

FIG. 5 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

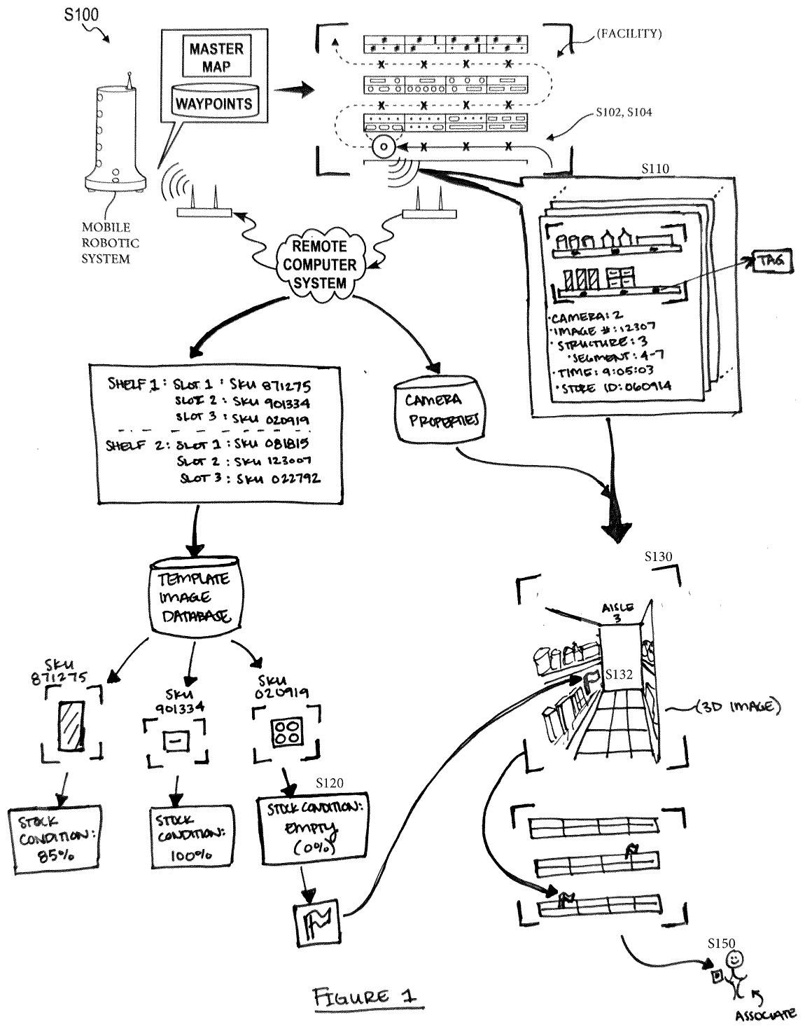

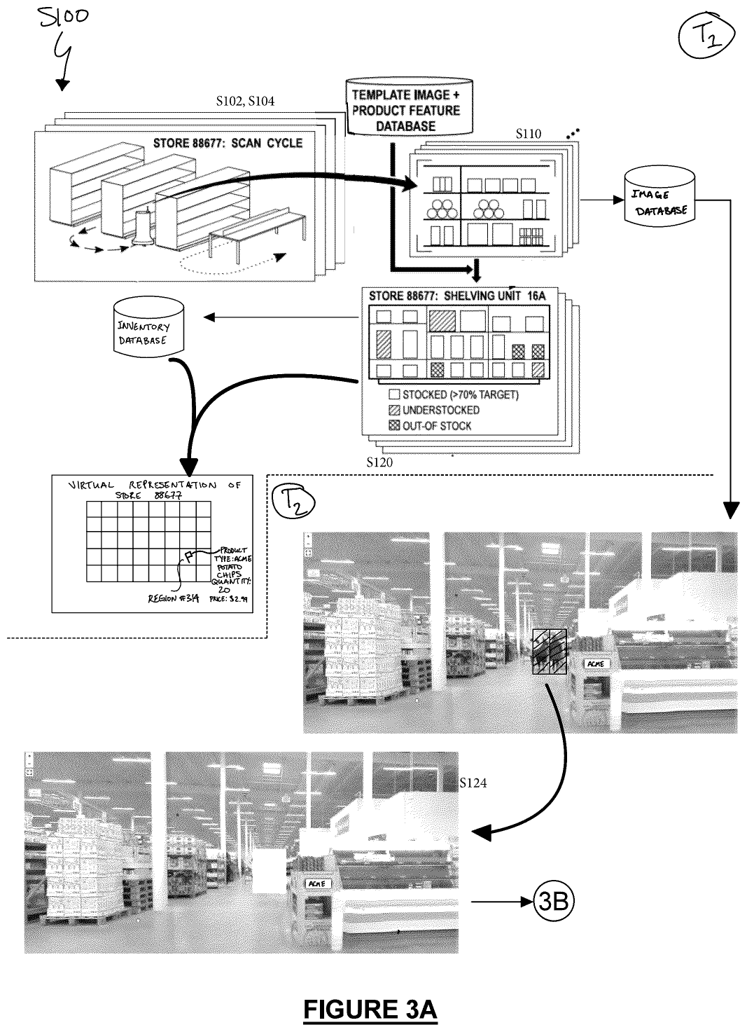

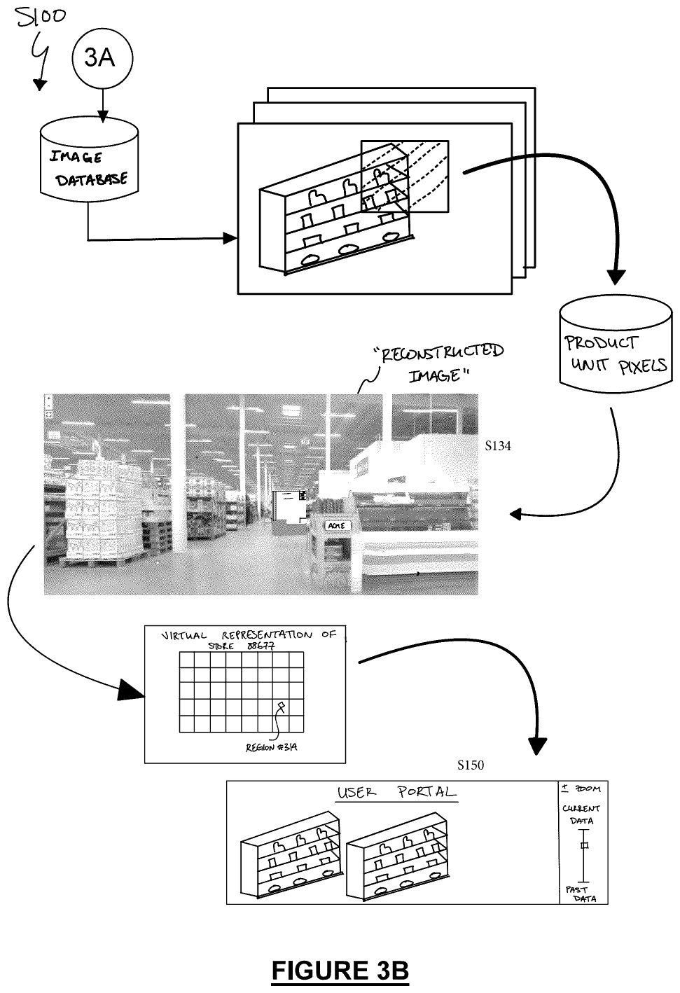

As shown in FIGS. 1, 2, 3A, 3B, 4, and 5, a method S100 for scanning and visualizing an interior environment of a facility includes, by a mobile robotic system: autonomously navigating along inventory structures within the facility in Block S102; and, during an initial scan cycle, capturing images of inventory structures within a facility via an optical sensor arranged in the mobile robotic system in Block S104. The method S100 further includes, by a computer system: accessing a first sequence of images of a first inventory structure, the first sequence of images captured by the mobile robotic system at a first time during the initial scan cycle in Block S110; identifying a first tag, arranged on the first inventory structure, depicted in a first region of a first image in the first sequence of images; detecting a first set of features in the first region of the first image, the first set of features representing a first product descriptor; retrieving a first set of template features of a first product associated with the first product descriptor from a database of template features; identifying a first slot, proximal the first tag, depicted in a second region of the first image; detecting absence of the first product in the first slot based on absence of features analogous to the first set of template features in the second region of the first image in Block S120; constructing a three-dimensional image of the first inventory structure based on the first sequence of images in Block S130; annotating the three-dimensional image with a first marker representing absence of product units of the first product type in the first slot in Block S132; and serving the three-dimensional image of the first inventory structure to a portal executing on a computing device accessed by an associate affiliated with the facility in Block S150.

In one variation, Block S110 of the method S100 recites: accessing the first sequence of images—captured by the mobile robotic system at the first time during the initial scan cycle—of the first inventory structure in a first aisle of the facility, the first aisle bounded by the first inventory structure and a second inventory structure. In this variation, the method S100 further includes, by the computer system: accessing a second sequence of images of the second inventory structure, the second sequence of images captured by the mobile robotic system at a second time during the initial scan cycle in Block S110; identifying a second tag, arranged on the second inventory structure, depicted in a third region of a second image in the second sequence of images; detecting a second set of features in the third region of the second image, the second set of features representing a second product descriptor; retrieving a second set of template features of a second product associated with the second product descriptor from the database of template features; identifying a second slot, proximal the second tag, depicted in a fourth region of the second image; detecting absence of the second product in the second slot based on absence of features analogous to the second set of template features in the fourth region of the second image in Block S120; constructing a second three-dimensional image of the second inventory structure based on the second sequence of images in Block S130; annotating the second three-dimensional image of the second inventory structure with a second marker representing absence of product units of the second product type in the second slot in Block S132; combining the three-dimensional image of the first inventory structure with the second three-dimensional image of the second inventory structure to generate a three-dimensional representation of the first aisle in Block S140; and serving the three-dimensional representation of the first aisle to the associate portal accessed by the associate in Block S150.

One variation of the method S100 includes, by a mobile robotic system: autonomously navigating along inventory structures within the facility in Block S102; and capturing images of regions within a facility and within a field of view of an optical sensor arranged in the mobile robotic system in Block S104. In this variation, the method S100 further includes, by a computer system: accessing a first sequence of images captured by the mobile robotic system autonomously traversing the facility in Block S110; and, for each image in the first sequence of images, extracting a set of features representing an inventory structure from the image and detecting a set of product units on the inventory structure. The method S100 further includes, for each product unit in the set of product units: interpreting a product type, in a set of product types, of the product unit; interpreting a location, in a set of locations, of the product unit; and interpreting a stock condition, in a set of stock conditions, of the product unit in Block S120. The method S100 further includes: assembling the first sequence of images into a three-dimensional representation of the inventory structure in Block S130; and annotating the three-dimensional representation of the inventory structure with the set of product types, the set of locations, and the set of stock conditions in Block S132.

### 1.1 Method: Three-Dimensional Representation of a First Aisle

One variation of the method S100 includes, by a mobile robotic system, autonomously navigating along inventory structures within the facility in Block S102 and capturing images of inventory structures within a facility via an optical sensor arranged in the mobile robotic system in Block S104. In this variation the method S100 further includes, by a computer system: accessing a first sequence of images of a first inventory structure, the first sequence of images captured by the mobile robotic system during a first scan cycle in Block S110; identifying a first set of slots in the first inventory structure based on features extracted from the first sequence of images; detecting absence of product units of a first set of product types in a first subset of slots, in the first set of slots, based on absence of features analogous to template features defined for the first set of product types in the first sequence of images in Block S120; accessing a second sequence of images of a second inventory structure forming a first aisle with the first inventory structure, the second sequence of images captured by the mobile robotic system during the first scan cycle in Block S110; identifying a second set of slots in the second inventory structure based on features extracted from the second sequence of images; detecting absence of product units of a second set of product types in a second subset of slots, in the second set of slots, based on absence of features analogous to template features defined for the second set of product types in the second sequence of images in Block S120; constructing a first three-dimensional image of the first inventory structure based on the first sequence of images in Block S130; annotating the first three-dimensional image with a first set of markers representing absence of product units of the first set of product types in the first subset of slots in Block S132; constructing a second three-dimensional image of the second inventory structure based on the second sequence of images in Block S130; annotating the second three-dimensional image with a second set of markers representing absence of product units of the second set of product types in the second subset of slots in Block S132; and constructing a three-dimensional representation of the first aisle based on the first three-dimensional image and the second three-dimensional image in Block S140.

### 1.2 Variation: Image Filtering

As shown in FIGS. 1A and 1B, one variation of the method S100 for scanning and visualizing an interior environment of a store includes, during a first time period: accessing a first sequence of images depicting regions within the facility and captured by a mobile robotic system autonomously traversing the facility in Block S110; for each image in the first sequence of images, extracting a set of features representing an inventory structure from the image; detecting a set of product units on the inventory structure; interpreting a product type and a location of each product unit in the set of product units during the first time period; assembling the first sequence of images into a composite image (e.g., a three-dimensional virtual representation, a two-dimensional panoramic image) of the inventory structure in Block S130; and annotating or associating regions of the composite image with product types and locations of product units in Block S132.

The method S100 further includes, during a second time period: accessing a first image depicting a first segment of an inventory structure in the facility and captured by the mobile robotic system in Block S110; detecting a human depicted in a first cluster of pixels, in a set of pixels, in the first image; and, in response to detecting the human in the first cluster of pixels of the first image, discarding the first cluster of pixels from the first image in Block S124.

The method S100 also includes: updating the composite image, depicting the inventory structure, according to data contained in the set of pixels, excluding the first cluster of pixels, in the first image in Block S134.

### 1.3 Variation: Hole Dimension+Stored Image Reconstruction

One variation of the method S100 includes, at a first time: accessing a first sequence of images depicting an inventory structure in the facility and captured by a mobile robotic system autonomously traversing the facility in Block S110; for each image in the first sequence of images, detecting a human depicted in a cluster of pixels in the image; in response to detecting the human in the cluster of pixels in the image, discarding the cluster of pixels from the image in Block S122; and assembling the first sequence of images into a composite image of the inventory structure in Block S130.

This variation of the method S100 further includes: identifying a hole in the composite image of the inventory structure; characterizing a dimension of the hole; in response to the dimension exceeding a target dimension for holes; accessing a stored image of a first segment of the inventory structure captured by the mobile robotic system prior to the first time; extracting a first cluster of pixels, containing data approximating the hole, from the stored image; projecting the first cluster of pixels onto the composite image of the inventory structure to fill the hole; and detecting a set of slots depicted in the composite image of the inventory structure.

This variation of the method S100 also includes, for each slot in the set of slots: extracting a set of features representing a set of product units in the slot from the composite image; deriving a stock condition of the slot based on the set of features; calculating a score of the stock condition in the slot inversely proportional to an age of the set of features and inversely proportional to a value of the set of product units in the slot; and converting the score of the stock condition into a color value.

The method S100 further includes: initializing a translucent heatmap layer representing the inventory structure; assigning a set of pixels in the translucent heatmap layer with corresponding color values of the set of slots; and superimposing the translucent heatmap layer onto the composite image of the inventory structure.

### 2. Applications

Generally, Blocks of the method S100 can be executed by a computer system (e.g., a remote computer system, a remote server): to access images (e.g., photographic images, depth images) of inventory structures and other product displays in a store (e.g., a grocery store, a clothing store, a warehouse) captured by a mobile robotic system and/or fixed cameras arranged in the facility; to derive stock conditions at these inventory structures (e.g., positions, orientations, counts, and/or facings of product unit in slots on these inventory structures) from these images; to autonomously construct, maintain, and update a (two- or) three-dimensional map representing an interior environment of the facility based on these images; to annotate this three-dimensional map with virtual identifiers linked to or indicating stock conditions in individual slots in these inventory structures; and to serve the three-dimensional map to a store associate or administrator, such as via a user portal. The computer system can thus enable the facility associate or administrator to virtually “walk around” the facility and to virtually view products on shelves within the facility.

For example, the computer system can execute Blocks of the method S100: to access a sequence of photographic images of the facility captured by the mobile robotic system during a scan cycle, such as during store closure or predicted low-occupancy hours in which no or minimal humans are present in the facility (e.g., between 3 AM and 4 AM or during a maintenance period); to access a sequence of depth images of the facility captured by the mobile robotic system during this scan cycle; and to stitch the sequence of photographic images and the sequence of depth images onto a three-dimensional color map of the facility.

The computer system can then: detect a set of slots in an inventory structure in the facility depicted in these color photographic images and/or depth images; detect a set of product units in the set of slots of the inventory structure; derive locations, counts, orientations, and product types of product units in the set of slots; and annotate the three-dimensional color map of the facility with virtual identifiers (e.g., flags, pins) linked to locations, counts, orientations, and product types of product units.

Later, the computer system can: access an image (e.g., photographic images, depth images) of an inventory structure in a region of the facility captured by the mobile robotic system during a scan cycle, such as during store operation or high-occupancy hours in which humans are present in the facility (e.g., between 8 AM and 8 PM); derive stock condition data (e.g., positions, orientations, and quantities of products on shelves in the inventory structure) from the image; identify object types within the image; remove or discard clusters of pixels depicting human object types from the image; and interpolate empty subregions of the image with corresponding subregions of a last stored image of this region of the facility in order to generate a reconstructed image depicting all features of product units in shelves of the inventory structure. The computer system can further assign a color value (e.g., a color range and a color intensity) to each remaining pixel in the image; and append the three-dimensional map of the facility with the image to update data for this region of the facility; and serve the three-dimensional map to a user portal, thereby enabling a user to view the state and stock condition data of shelves in the facility during any current or past time period with no or minimal exposure of sensitive information (e.g., store associate information, customer information) to the user.

In particular, the computer system can characterize a dimension of the hole in the image (e.g., a size of the hole, a width of the hole, a height of the hole, or a quantity of absent pixels in the image) and responsive to the dimension falling below the target dimension for images: append the three-dimensional map of the facility with the current image to update data for this region of the facility; retrieve a last stored image of the inventory structure in this region of the facility previously captured by the mobile robotic system; extract a cluster of pixels, cospatial with the discarded cluster of pixels in the current image, from the last stored image; and project this cluster of pixels onto the three-dimensional map to replace the discarded cluster of pixels to prevent depiction of partial features of a product unit in the three-dimensional map. The computer system can further: assign a first color value to the remaining pixels from the current image to indicate a current data age of these pixels (e.g., most recent data); assign a second color value to the cluster of pixels extracted from the last stored image to indicate a past data age of these pixels (e.g., older data); and populate corresponding pixels in the three-dimensional map with these color values to generate a data age heatmap for this region of the facility.

Alternatively, responsive to absence of a last stored image of the inventory structure in this region of the facility within the remote database, the computer system can: append the three-dimensional map of the facility with the current image; access a template image database representing stock images of products for this store; retrieve a stock image of a product unit corresponding to a partial product unit depicted in the three-dimensional map; skew the stock image (e.g., apply a horizontal slant to an image, apply a vertical slant to an image) and scale the stock image (e.g., resize the image by increasing the pixel information of the image, resize the image by decreasing the pixel information of the image) to match with the scale of the three-dimensional map; and align with remaining pixels representing the partial product unit in the three-dimensional map. The computer system can further populate the three-dimensional map of the facility with a color value to highlight synthetic features of the product unit from the stock image.

Therefore, the computer system can execute Blocks of the method S100 to enable a user: to view the current state of shelves in the facility (e.g., with a latency of minutes or up to several hours since a last scan cycle at the facility); to virtually “walk through” a three-dimensional representation of the interior environment of the facility; and to remotely monitor stock condition data associated with a region of interest to the user within the facility during a past time period and/or a current time period.

The method S100 is described herein as executed by the computer system to autonomously process images of shelving structures, inventory structures, and promotional displays in a store captured by a mobile robotic system and to construct, maintain, and update a three-dimensional map of the facility. However, the computer system can similarly execute Blocks of the method S100 to autonomously process images of a refrigeration unit, a wall rack, a cubby, a freestanding floor rack, a table, a hot-food display, a produce display, or any other product organizer, display, or other inventory structure in a retail space.

Furthermore, the method S100 is generally described herein as executed by the computer system to autonomously process images captured by a mobile robotic system configured to autonomously navigate throughout the facility. However, the computer system can similarly execute Blocks of the method S100 to autonomously process images captured by a set of fixed cameras installed within the facility and/or by the mobile robotic system.

### 2.1 2D+3D Image Streams

In one implementation, the computer system maintains both: a two-dimensional image stream for deriving insights related to product inventory and facility management; and a three-dimensional image stream for presenting these insights to a human user (i.e., a store associate).

In particular, in this implementation, the computer system can: access two-dimensional photographic images and/or depth images—captured by the mobile robotic system autonomously navigating throughout the facility—of an inventory structure; and leverage these two-dimensional images to detect slots in the inventory structure and derive stock conditions of products within these slots based on features extracted from these images. The computer system can also: stitch these images into a panoramic image of the inventory structure; and/or leverage known intrinsic and extrinsic properties of each camera, in a set of cameras integrated in the mobile robotic system, to construct a three-dimensional image of the inventory structure from two-dimensional photographic images and/or depth images captured by the mobile robotic system. The computer system can then: annotate this three-dimensional image of the inventory structure with a set of markers indicating stock conditions—such as out-of-stock, low stock, fully-stocked, etc.—of slots in the inventory structure; and present this three-dimensional image—annotated accordingly—to a store associate with the associate portal.

The computer system can then repeat this process for each inventory structure in the facility to: construct an annotated, three-dimensional image of each inventory structure in the facility; construct three-dimensional representations of each aisle—including aisle infrastructure (e.g., lighting fixtures, signage, refrigeration units)—in the facility by combining three-dimensional images of pairs of inventory structures forming each aisle; and/or construct a three-dimensional map of the facility by combining three-dimensional representations of each aisle and/or other regions of the facility. The computer system can then present this three-dimensional map to the store associate via the associate portal. Therefore, the computer system can: complete all object detection and deriving of insights via analysis of two-dimensional images, thereby reducing an amount of compute required; and package these insights into a three-dimensional representation or map for viewing by the store associate, which may be more easily interpreted by the store associate.

### 3. Robotic System

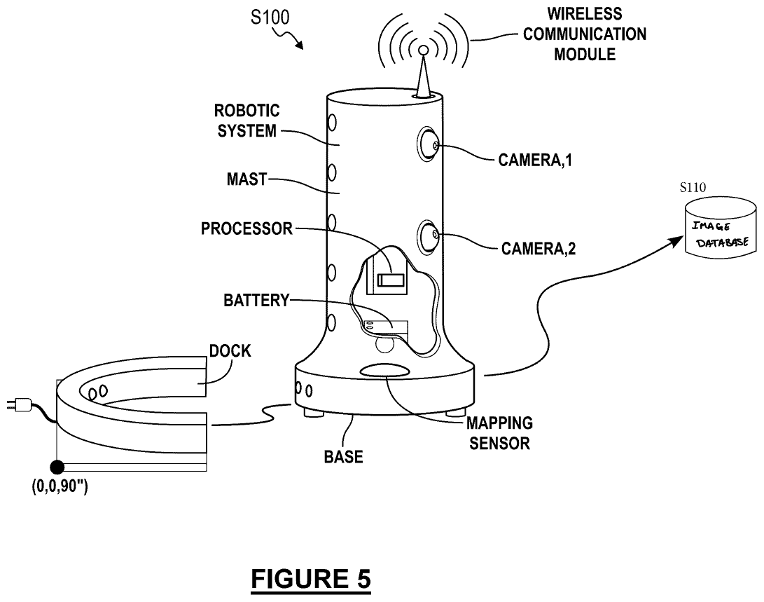

As shown in FIG. 5, a mobile robotic system autonomously navigates throughout a store and records images—such as photographic images of packaged goods and/or depth images of inventory structures—continuously or at discrete predefined waypoints throughout the facility during a scan cycle. Generally, the mobile robotic system can define a network-enabled mobile robot configured to autonomously: traverse a store; capture photographic (e.g., color, black-and-white) and/or depth images of shelving structures, shelving segments, shelves, slots, or other inventory structures within the facility; and upload those images to the computer system for analysis, as described below.

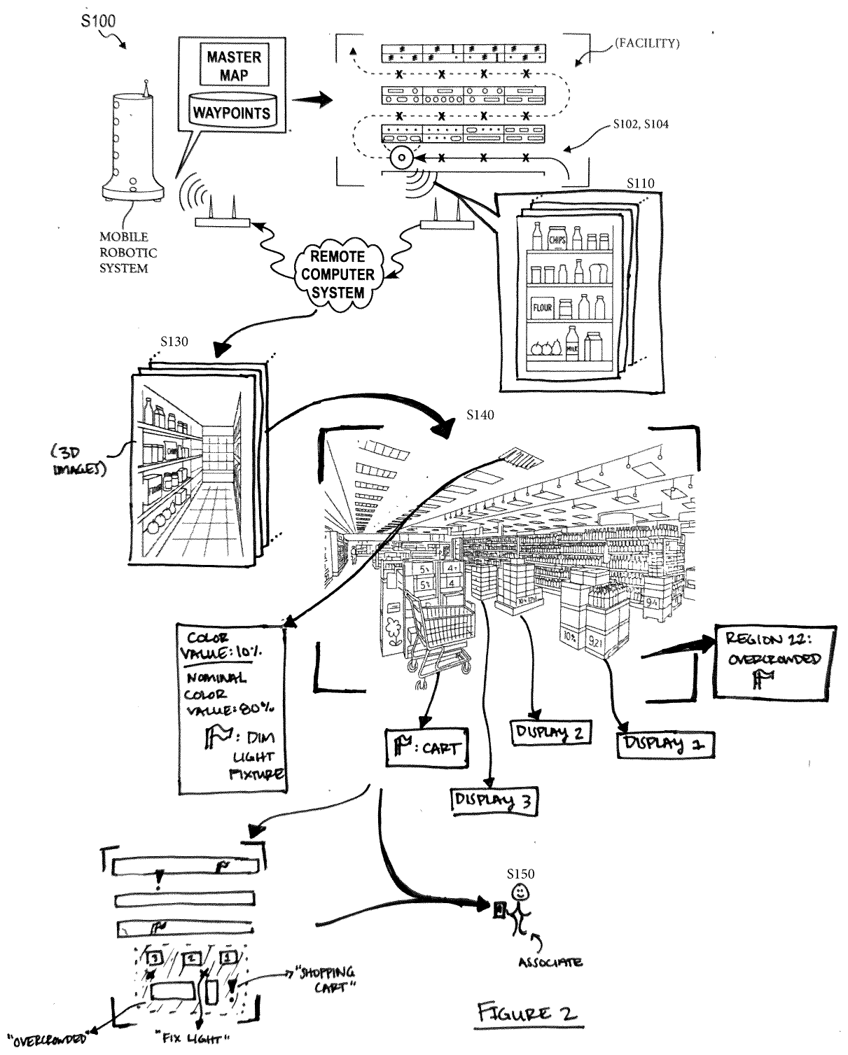

In one implementation, the mobile robotic system defines an autonomous imaging vehicle including: a base; a drive system (e.g., a pair of two driven wheels and two swiveling castors) arranged in the base; a power supply (e.g., an electric battery); a set of mapping sensors (e.g., fore and aft scanning LIDAR systems configured to generate depth images); a processor that transforms data collected by the mapping sensors into two- or three-dimensional maps of a space around the mobile robotic system; a mast extending vertically from the base; a set of photographic cameras arranged on the mast; and a wireless communication module that downloads waypoints and a master map of a store from a computer system (e.g., a remote server) and that uploads photographic images captured by the photographic camera and maps generated by the processor to the computer system, as shown in FIG. 5. In this implementation, the mobile robotic system can include photographic cameras mounted statically to the mast, such as a first vertical array of (e.g., two, six) photographic cameras on a left side of the mast and a second vertical array of photographic cameras on the right side of the mast, as shown in FIG. 2.

In one variation, the mobile robotic system includes articulable photographic cameras, such as: one photographic camera on the left side of the mast and supported by a first vertical scanning actuator; and one photographic camera on the right side of the mast and supported by a second vertical scanning actuator. The mobile robotic system also includes a zoom lens, a wide-angle lens, or any other type of lens on each photographic camera. Each photographic camera can include: a color camera configured to record and output two-dimensional color images; and/or a set of depth cameras configured to record and output two-dimensional depth images or three-dimensional point clouds. However, the photographic camera can define any other type of optical sensor and can output visual or optical data in any other format.

Furthermore, multiple robotic systems can be deployed in a single store and can be configured to cooperate to image shelves, product units, and the environment within the facility. For example, two robotic systems can be deployed to a large single-floor retail store and can cooperate to collect images of all aisles, shelves, ground surfaces, and inventory structures in the facility within a threshold period of time (e.g., within one hour). In another example, one robotic system is deployed on each floor of a multi-floor store, and each robotic system collects images of aisles, shelves, ground surfaces, and inventory structures on its corresponding floor.

However, the mobile robotic system can define any other form and can include any other subsystems or elements supporting autonomous navigation and image capture throughout a store environment.

### 4. Hierarchy and Terms

A “store” is referred to herein as a (static or mobile) facility containing one or more inventory structures.

A “product” is referred to herein as a type of loose or packaged good associated with a particular product identifier (e.g., a SKU) and representing a particular class, type, and varietal. A “unit” or “product unit” is referred to herein as an instance of a product—such as one bottle of detergent, one box of cereal, or package of bottled water—associated with one SKU value.

A “product facing” is referred to herein as a side of a product designated for a slot.

A “slot” is referred to herein as a section (or a “bin”) of a shelf on an “inventory structure” designated for storing and displaying product units of the product type (i.e., of the same SKU or CPU). An inventory structure can include a shelving segment, a shelving structure, or other product display containing one or more slots on one or more shelves.

Furthermore, a “realogram” is referred to herein as a representation of the actual products, actual product placement, actual product quantity, and actual product orientation of products and product units throughout the facility during a scan cycle, such as derived by the computer system according to Blocks of the method S100 based on photographic images and/or other data recorded by the mobile robotic system while autonomously executing scan cycles in the facility.

### 5. Associate Portal

In one implementation, the computer system can interface with an associate portal executing on a computing device (e.g., a smartphone, a tablet, a laptop, a desktop computer) accessed by an associate affiliated with the facility.

Generally, in this implementation, the computer system can: leverage images captured by the mobile robotic system to generate three-dimensional images or representations of an inventory structure(s), an aisle(s), and/or an entire facility; and selectively present these three-dimensional images to the associate via the associate portal.

For example, the computer system can implement methods and techniques described further below to generate a virtual, three-dimensional map of the facility—annotated with stock conditions of product units in slots in inventory structures arranged throughout the facility—and serve this virtual, three-dimensional map of the facility to the associate portal for access by the associate. Then, in response to receipt of a query for inventory data associated with products on a first inventory structure (e.g., within a first aisle) in the facility, the computer system can: access a three-dimensional image—integrated into the virtual, three-dimensional map of the facility—of the first inventory structure; and render this three-dimensional image within the associate portal.

Additionally or alternatively, in another example, the computer system can: receive a request to view products of a particular product type and/or associated with a particular brand from an instance of the associate portal (e.g., accessed by the associate); and automatically serve a corresponding set of three-dimensional images—depicting products of the particular product type and/or associated with the particular brand in one or more slots or displays within the facility—to the instance of the associate portal.

Therefore, the computer system can enable the associate to selectively view various regions of the facility and/or investigate inventory data in a specific region of the facility and/or for specific product types accordingly.

### 6. Robotic System Deployment and Scan Cycle

Blocks S102 and S104 of the method S100 recite: by a mobile robotic system: autonomously navigating along inventory structures within the facility; and capturing images of inventory structures within a facility via an optical sensor arranged in the mobile robotic system.

Generally, the computer system can dispatch the mobile robotic system to autonomously navigate through a store and to record images of inventory structures within the facility during a scan cycle. More specifically, the computer system can dispatch the mobile robotic system to autonomously navigate along a preplanned sequence of waypoints or along a dynamic path and to record photographic images and/or depth images of inventory structures throughout the facility.

### 6.1 Scan Cycle: Waypoints

In one implementation, the computer system: defines a set of waypoints specifying target locations within the facility through which the mobile robotic system navigates and captures images of inventory structures throughout the facility during a scan cycle; and intermittently (e.g., twice per day) dispatches the mobile robotic system to navigate through this sequence of waypoints and to record images of inventory structures nearby during a scan cycle.

For example, the mobile robotic system can be installed within a store, and the computer system can dispatch the mobile robotic system to execute a scan cycle during store hours, including navigating to each waypoint throughout the facility and collecting data representative of the stock state of the facility in near real-time as patrons move, remove, and occasionally return product on, from, and to inventory structures within the facility (e.g., shelving structures, refrigeration units, inventory structures, hanging racks, cubbies, etc.). During this scan cycle, the mobile robotic system can: record photographic (e.g., color, black-and-white) images of each inventory structure; record depth images of all or select inventory structures; and upload these photographic and depth images to the computer system, such as in real-time or upon conclusion of the scan cycle. The computer system can then: detect types and quantities of packaged goods stocked in slots on these inventory structures in the facility based on data extracted from these photographic and depth images; and aggregate these data into a realogram of the facility.

Therefore, the computer system can maintain, update, and distribute a set of waypoints to the mobile robotic system, wherein each waypoint defines a location within a store at which the mobile robotic system is to capture one or more images from the integrated photographic and depth cameras. In one implementation, the computer system defines an origin of a two-dimensional Cartesian coordinate system for the facility at a charging station—for the mobile robotic system—placed in the facility, and a waypoint for the facility defines a location within the coordinate system, such as a lateral (“x”) distance and a longitudinal (“y”) distance from the origin. Thus, when executing a waypoint, the mobile robotic system can navigate to (e.g., within three inches of) a (x,y) coordinate of the facility as defined in the waypoint. For example, for a store that includes shelving structures with four-foot-wide shelving segments and six-foot-wide aisles, the computer system can define one waypoint laterally and longitudinally centered—in a corresponding aisle—between each opposite shelving segment pair. A waypoint can also define a target orientation, such as in the form of a target angle (“∂”) relative to the origin of the facility, based on an angular position of an aisle or shelving structure in the coordinate system. When executing a waypoint, the mobile robotic system can orient to (e.g., within 1.5° of) the target orientation defined in the waypoint in order to align the suite of photographic and depth cameras to an adjacent shelving structure or inventory structure.

During navigation to a next waypoint, the mobile robotic system can scan its environment with the same or other depth sensor (e.g., a LIDAR sensor, as described above), compile depth scans into a new map of the mobile robotic system's environment, determine its location within the facility by comparing the new map to a master map of the facility defining the coordinate system of the facility, and navigate to a position and orientation within the facility at which the output of the depth sensor aligns—within a threshold distance and angle—with a region of the master map corresponding to the (x,y,∂) location and target orientation defined in this next waypoint.

In this implementation, prior to initiating a new scan cycle, the mobile robotic system can download—from the computer system—a set of waypoints, a preferred order for the waypoints, and a master map of the facility defining the coordinate system of the facility. Once the mobile robotic system leaves its dock at the beginning of a scan cycle, the mobile robotic system can repeatedly sample its integrated depth sensors (e.g., a LIDAR sensor) and construct a new map of its environment based on data collected by the depth sensors. By comparing the new map to the master map, the mobile robotic system can track its location within the facility throughout the scan cycle. Furthermore, prior to navigating to a next scheduled waypoint, the mobile robotic system can confirm completion of the current waypoint based on alignment between a region of the master map corresponding to the (x,y,∂) location and target orientation defined in the current waypoint and a current output of the depth sensors, as described above.

However, the mobile robotic system can implement any other methods or techniques to navigate to a position and orientation in the facility that falls within a threshold distance and angular offset from a location and target orientation defined by a waypoint.

### 6.2 Scan Cycle: Dynamic Path

In one implementation, during a scan cycle, the mobile robotic system can autonomously generate a path through the facility and execute this path in real-time based on: obstacles (e.g., patrons, spills, inventory structures) detected nearby; priority or weights previously assigned to inventory structures or particular slots within the facility; and/or product sale data from a point-of-sale system connected to the facility and known locations of products in the facility, such as defined in an inventory database for the facility. For example, the computer system can dynamically generate a path through the facility during a scan cycle to maximize a value of inventory structures or a particular product recorded by the mobile robotic system per unit time responsive to dynamic obstacles within the facility (e.g., patrons, spills), such as described in U.S. patent application Ser. No. 15/347,689. In this implementation, the mobile robotic system can then continuously capture photographic images and/or depth images of inventory structures in the facility (e.g., at a rate of 10 Hz, 24 Hz). However, the mobile robotic system can capture images of inventory structures within the facility at any other frequency during a scan cycle.

In one variation, the mobile robotic system records multiple initialization images of all regions in a store in multiple lighting conditions (e.g., bright, daylight, dark) to improve object detection and alignment of images (e.g., photographic images, depth images) across these lighting conditions in order to generate a three-dimensional map of the facility. The computer system then accesses lighting conditions associated with each region of the facility to dynamically generate a path through the facility during a scan cycle to maximize object recognition of shelf faces, slots, and product units on inventory structures within each region of the facility.

### 7. Image Access

Generally, the mobile robotic system can return images (e.g., photographic and/or depth images) recorded during a scan cycle to a remote database, such as in real-time during the scan cycle, upon completion of the scan cycle, or during scheduled upload time windows within the scan cycle. The computer system can then access an image of an inventory structure, captured by the mobile robotic system during the scan cycle, from this remote database.

In one implementation, the computer system processes individual photographic images to identify product units depicted in these individual images. Further, the computer system can: stitch multiple photographic images into one composite photographic image representing a length of one inventory structure or of multiple adjacent inventory structures; and then process this “composite” photographic image according to methods and techniques described below. Alternatively, the computer system can: stitch multiple depth images into one composite depth image representing the length of one inventory structure or of multiple adjacent inventory structures; and then process this “composite” depth image according to methods and techniques described below.

### 8. Data Processing

Generally, the computer system can: dispatch the mobile robotic system to the facility during a time period associated with human absence, such as during store closure, predicted low-occupancy hours (e.g., between 3 AM and 4 AM), or during a maintenance period for a first scan cycle; access images (e.g., color images and depth images) captured by the mobile robotic system while navigating along a dynamic path in real-time during the first scan cycle and/or upon termination of the first scan cycle; process these images to extract data (e.g., stock condition data, product type data, address data); and manipulate these images and data to derive a three-dimensional representation of the facility.

In one implementation, the computer system: accesses a sequence of photographic images and depth images, captured by the mobile robotic system during a scan cycle, from the remote database; and stitches the sequence of photographic images into a composite image representing a region of the facility or multiple regions of the facility. The computer system further implements simultaneous localization and mapping (or “SLAM”) techniques, photogrammetry techniques, stereo vision techniques, and/or other computer vision techniques to: autonomously assemble the sequence of depth images into a two-dimensional depth map of the facility; and derive a three-dimensional map of the facility based on a combination of the composite images and the two-dimensional depth map.

In one variation, the computer system: accesses a sequence of photographic images of an inventory structure in the facility captured by the mobile robotic system during a scan cycle; accesses a sequence of depth images of the inventory structure captured by the mobile robotic system during this scan cycle; and combines the sequence of photographic images and the sequence of depth images into a composite image (e.g., a three-dimensional virtual representation, a two-dimensional panoramic image) of the inventory structure. The computer system can repeat these methods and techniques for each other scan cycle and for each other inventory structure to assemble a three-dimensional virtual representation of the interior environment of the facility.

In another variation, the computer system: compiles color images, captured by the mobile robotic system, into a composite image of each region of the facility; and/or combines color images and depth images captured by the mobile robotic system to assemble a color three-dimensional map of the facility.

Furthermore, the computer system can annotate the three-dimensional map of the facility with virtual identifiers representing addresses—such as a slot, a shelf, a shelf facing, a shelving segment, a shelving structure, an inventory structure, or an aisle address—linked to stock condition data (e.g., locations, orientations, product types, and quantities of product units) to enable a user to virtually navigate between regions of the facility and select individual virtual identifiers within the three-dimensional map to remotely access stock condition data of the facility.

### 8.1 Three-Dimensional Representation

Generally, the computer system can: initialize a virtual environment of the facility; and assemble color and depth images captured by the mobile robotic system of a set of regions, in the facility, during a scan cycle into the virtual environment to form a three-dimensional representation of the facility.

In one implementation, the computer system: accesses a first set of near-field images of a first region of the facility, captured by a left near-field camera and a right near-field camera of the mobile robotic system, from the remote database; accesses a second set of near-field images of the first region of the facility, captured by a right near-field camera of the mobile robotic system; stitches the first set and the second set of near-field images into a composite image of the first region of the facility; accesses a set of depth images of this region of the facility; and layers the set of depth images onto the composite image to construct a three-dimensional representation of the first region of the facility.

The computer system can repeat the methods and techniques described above for each other region of the facility to construct a set of three-dimensional representations of the facility and to compile the set of three-dimensional representations into a three-dimensional map of the facility.

For example, the computer system can: access a sequence of photographic images depicting a first inventory structure in the facility, captured by the mobile robotic system, from the image database; stitch the sequence of photographic images into a first panoramic photographic image representing a first length of the first inventory structure; access a second sequence of photographic images depicting a second inventory structure, adjacent the first inventory structure, from the image database; stitch the second sequence of photographic images into a second panoramic photographic image representing a length of the second inventory structure; and stitch the first panoramic photographic image and the second panoramic photographic image into a composite image. The computer system can then: access a sequence of depth images of the first inventory structure in the facility; access a second sequence of depth images of the second inventory structure in the facility; and combine the first and second sequences of depth images with the composite image to construct a three-dimensional virtual representation of a region of the facility including the first inventory structure and the second inventory structure.

Additionally or alternatively, the mobile robotic system can implement the methods and techniques described above: to construct a three-dimensional representation of each region of the facility; and to offload these three-dimensional representations to the remote database. The computer system can then access the remote database and assemble these three-dimensional representations of regions of the facility into a three-dimensional map of the facility.

### 8.1.1 First Inventory Structure

Block S110 of the method S100 recites accessing a first sequence of images of a first inventory structure, the first sequence of images captured by the mobile robotic system at a first time during the initial scan cycle.

Generally, the computer system can: access a first sequence of images—including photographic and/or depth images captured by one or more optical sensors integrated within the mobile robotic system—of the first inventory structure forming a first side of an aisle (i.e., a walkway between rows of inventory structures) in the facility.

In particular, the mobile robotic system can: autonomously navigate through the aisle of the facility and simultaneously capture the first sequence of images; and upload the first sequence of images to an image database (e.g., a remote database), such as in real-time during the scan cycle or upon completion of the scan cycle. The computer system can then retrieve the first sequence of images from this image database.

In one implementation, the computer system can: stitch multiple images, in the first sequence of images captured by the mobile robotic system, into one composite image representing a length of the first inventory structure; and then process this “composite” image according to methods and techniques described below. In particular, in one example, the computer system can: stitch multiple photographic images into one composite photographic image representing a length of the first inventory structure; and then process this composite photographic image according to methods and techniques described below. Additionally or alternatively, in another example, the computer system can: stitch multiple depth images, in the first sequence of images, into one composite depth image representing the length of the first inventory structure; and then process this composite depth image according to methods and techniques described below.

### 8.1.1.1 2D Images: Product Detection & Stock Conditions

Block S120 of the method S100 recites: detecting absence of product units of the first product type in the first slot based on absence of features analogous to the first set of template features in the second region of the first image.

Generally, the computer system can leverage two-dimensional images (e.g., photographic images) of the first inventory structure to: identify product units depicted in individual images; detect presence and/or absence of product units of a set of product types in slots on the first inventory structure; and/or derive a stock condition (e.g., no stock, low stock, fully stocked) for a particular product type corresponding to a slot on the first inventory structure.

In particular, the computer system can: access the first sequence of images of the first inventory structure—captured by the mobile robotic system—as described above; identify a first tag (e.g., a shelf tag), arranged on the first inventory structure, depicted in a first region of a first image in the first sequence of images; detect a first set of features in the first region of the first image, the first set of features representing a first product descriptor; retrieve a first set of template features of a first product type associated with the first product descriptor from a database of template features; identify a first slot, proximal the first tag, depicted in a second region of the first image; and, based on features extracted from the second region of the first image, interpret a stock condition of the first product type in the first slot. For example, the computer system can detect absence of product units of the first product type in the first slot based on absence of features analogous to the first set of template features in the second region of the first image. Alternatively, the computer system can detect presence—such as characterized by a particular quantity of product units—of product units of the first product type in the first slot based on presence of features analogous to the first set of template features in the second region of the first image.

The computer system can then repeat this process for each slot, in a set of slots, defined by the first inventory structure, to derive stock conditions for product units in each slot, in the set of slots, across the first inventory structure.

For example, the computer system can: identify a second tag (e.g., a shelf tag), arranged on the first inventory structure, depicted in a third region of the first image; detect a second set of features in the first region of the first image, the second set of features representing a second product descriptor; retrieve a second set of template features of a second product type associated with the second product descriptor from the database of template features; identify a second slot, proximal the second tag and adjacent the first slot, depicted in a fourth region of the first image; and, based on features extracted from the fourth region of the first image, interpret a second stock condition of the second product type in the second slot. Furthermore, the computer system can: identify a third tag (e.g., a shelf tag), arranged on the first inventory structure, depicted in a fifth region of a second image in the first sequence of images; detect a third set of features in the fifth region of the second image, the third set of features representing a third product descriptor; retrieve a third set of template features of a third product type associated with the third product descriptor from the database of template features; identify a third slot, proximal the third tag, depicted in a sixth region of the second image; and, based on features extracted from the sixth region of the second image, interpret a third stock condition of the third product type in the third slot.

### 8.1.1.2 Construct 3D Image

Blocks of the method S100 recite: constructing a three-dimensional image of the first inventory structure based on the first sequence of images in Block S130; annotating the three-dimensional image with a first marker representing absence of product units of the first product type in the first slot in Block S132; and serving the three-dimensional image of the first inventory structure to a portal executing on a computing device accessed by an associate affiliated with the facility in Block S150.

Generally, the computer system can leverage the first sequence of images—such as including photographic images and/or depth images captured by one or more optical sensors integrated within the mobile robotic system—to generate a three-dimensional image of the first inventory structure.

For example, the mobile robotic system can include a set of cameras configured to capture two-dimensional photographic images and depth images and defining overlapping fields of view. During a scan cycle, the mobile robotic system can capture the first sequence of images—including both two-dimensional photographic images and depth images—depicting overlapping sections of the first inventory structure. The computer system can then: access this first sequence of images; and leverage known intrinsic properties (e.g., focal length, principal point, distortion) and extrinsic properties (e.g., camera position and orientation) of each camera in the set of cameras—in combination with the first sequence of images—to construct a three-dimensional image of the first inventory structure. Therefore, the computer system can leverage two-dimensional images—captured by the mobile robotic system—of the first inventory structure to construct a three-dimensional image of the first inventory structure that exhibits accurate spatial geometry, colors, and/or textures. The computer system can then serve this three-dimensional image of the first inventory structure to the associate portal for viewing by one or more store associates within the associate portal.

Furthermore, the computer system can selectively annotate the three-dimensional image with stock conditions of product units in slots of the first inventory structure. For example, as described above, the computer system can derive stock conditions for product units in each slot, in the set of slots, across the first inventory structure. Then, in response to detecting absence of product units of a first product type in a first slot in the first inventory structure, the computer system can annotate the three-dimensional image with a first marker (e.g., a color-coded marker, a text label, a flag symbol) representing absence of product units of the first product type in the first slot. The computer system can repeat this process to annotate the three-dimensional image with a set of markers indicating empty slots—or absence of product units within these slots—throughout the first inventory structure. Therefore, the associate viewing the three-dimensional image may easily and/or rapidly identify slots with empty stock conditions.

Additionally or alternatively, the computer system can link each stock condition—derived for each slot in the set of slots in the first inventory structure—to the corresponding slot depicted in the three-dimensional image, such that the associate viewing the three-dimensional image (e.g., in the associate portal) may selectively view a stock condition for a particular slot in the set of slots. For example, the associate may view the three-dimensional image of the first inventory structure and select (e.g., via a touch input or a cursor) a first slot in the set of slots of the first inventory structure. Then, in response to selection of the first slot by the associate, the computer system can render a first stock condition—of product units of a first product type assigned to the first slot—adjacent and/or over the first slot within the three-dimensional image.

### 8.1.2 Aisle: First & Second Inventory Structures

In one variation, Blocks of the method S100 recite: accessing a second sequence of images—captured by the mobile robotic system at a second time during the initial scan cycle—of a second inventory structure in a first aisle of the facility bounded by the first inventory structure and the second inventory structure; constructing a second three-dimensional image of the second inventory structure based on the second sequence of images; and combining the three-dimensional image of the first inventory structure with the second three-dimensional image of the second inventory structure to generate a three-dimensional representation of the first aisle.

Generally, the computer system can: repeat the process described above to construct a second three-dimensional image of a second inventory structure forming a first aisle with the first inventory structure; and combine these three-dimensional images of the first inventory structure and the second inventory structure to generate a three-dimensional representation of the first aisle annotated with stock conditions of product units in slots throughout the first and second inventory structures.

In particular, the computer system can implement the methods and techniques described above to construct a three-dimensional image of the first inventory structure and annotate the three-dimensional image with a first set of markers—including the first marker representing absence of product units of the first product type in the first slot—representing stock conditions of products in slots in the first inventory structure. Then, the computer system can: access a second sequence of images—captured by the mobile robotic system at a second time during the initial scan cycle—of the second inventory structure; identify a second tag, arranged on the second inventory structure, depicted in a first region of a second image in the second sequence of images; detect a second set of features in the first region of the second image, the second set of features representing a second product descriptor; retrieve a second set of template features of a second product type associated with the second product descriptor from the database of template features; identify a second slot, proximal the second tag, depicted in a second region of the second image; detect absence of the second product in the second slot based on absence of features analogous to the second set of template features in the second region of the second image; and construct a second three-dimensional image of the second inventory structure based on the second sequence of images. The computer system can then: annotate the second three-dimensional image of the second inventory structure with a second marker representing absence of product units of the second product type in the second slot; and repeat this process to annotate the second three-dimensional image annotated with a second set of markers representing stock conditions of products in slots in the second inventory structure.

Finally, the computer system can: combine the first three-dimensional image of the first inventory structure with the second three-dimensional image of the second inventory structure to generate a three-dimensional representation of the first aisle; and serve the three-dimensional representation of the first aisle—annotated with stock conditions of product units in slots of the first and second inventory structures—to the associate portal accessed by the associate.

Therefore, the computer system can generate a virtual, three-dimensional representation of the first aisle—depicting all slots in inventory structures within the aisle and corresponding stock conditions—that may be viewed by the associate regardless of whether the associate is local or remote from the facility, thereby enabling the associate to remotely monitor data (e.g., stock condition data, product data) associated with the first aisle within the facility. Furthermore, based on the three-dimensional representation of the first aisle, the computer system can generate a three-dimensional walkthrough of the first aisle configured to enable the associate to virtually navigate through the three-dimensional representation of the first aisle; and serve this three-dimensional walkthrough to the associate portal for access by the associate.

### 8.1.3 Multiple Aisles: Mapping the Facility

Furthermore, the computer system can repeat the preceding process to: construct a three-dimensional image of each inventory structure, in a set of inventory structures, distributed throughout the facility; and combine three-dimensional images—corresponding to pairs of inventory structures forming aisles within the facility—of corresponding inventory structures to generate a three-dimensional representation of each aisle (i.e., a walkway between rows of inventory structures), in a set of aisles, in the facility.

In particular, as described above, the computer system can: construct a first three-dimensional image of the first inventory structure and annotate the first three-dimensional image with a first set of markers—including the first marker representing absence of product units of the first product type in the first slot—representing stock conditions of products in slots in the first inventory structure; construct a second three-dimensional image of the second inventory structure and annotate the second three-dimensional image with a second set of markers—including the second marker representing absence of product units of the second product type in the second slot—representing stock conditions of products in slots in the second inventory structure; and combine the first and second three-dimensional images to generate a first three-dimensional representation of the first aisle.

The computer system can then implement the methods and techniques described above to further: access a third sequence of images of a third inventory structure captured by the mobile robotic system during the initial scan cycle, the third inventory structure in a second aisle bounded by the third inventory structure and a fourth inventory structure; construct a third three-dimensional image of the third inventory structure based on the third sequence of images; access a fourth sequence of images of the fourth inventory structure captured by the mobile robotic system during the initial scan cycle; construct a fourth three-dimensional image of the fourth inventory structure based on the fourth sequence of images; and combine the third three-dimensional image of the third inventory structure with the fourth three-dimensional image of the fourth inventory structure to generate a second three-dimensional representation of the second aisle.

Finally, the computer system can combine the first three-dimensional representation of the first aisle with the second three-dimensional representation of the second aisle to generate a three-dimensional map—annotated with markers representing stock conditions of products in slots in inventory structures throughout the facility—of the facility. The computer system can thus present this three-dimensional map of the facility to the associate via the associate portal.

The computer system can thus: repeat this process to generate a set of three-dimensional representations—including the first and second three-dimensional representations of the first and second aisles—of a set of aisles throughout the facility; and compile these three-dimensional representations of the set of aisles into a three-dimensional map of the facility. Furthermore, the computer system can: generate a three-dimensional walkthrough of the facility based on the three-dimensional map of the facility; and present the three-dimensional walkthrough of the facility to the associate portal for virtual navigation of the facility by the associate, thereby enabling the associate to remotely monitor data (e.g., stock condition data, product data) associated with all inventory throughout the facility and view these conditions within the facility accordingly.

In one example, the computer system can output a three-dimensional map of the facility annotated with markers representing absence of product units in slots at various locations throughout the facility. Additionally or alternatively, the computer system can automatically generate a virtual walkthrough depicting a route through the facility to re-stock product units in these slots accordingly. The computer system can then serve this three-dimensional map and/or virtual walkthrough to a store associate for re-stocking out-of-stock products in the facility.

### 8.1.4 Facility: Stand-Alone Displays

In one implementation, the computer system: generates three-dimensional representations of regions of the facility external a defined aisle, such as including aisle end caps, produce regions, stand-alone product displays, etc.; and incorporates these three-dimensional representations into the three-dimensional map of the facility.

In one example, the computer system can: access a sequence of images of a first product display—such as corresponding to a temporary display of product units of a first product type stacked in a first configuration—captured by the mobile robotic system; implement the methods and techniques described above to construct a three-dimensional image of the first product display based on the sequence of images; and compile this three-dimensional image of the first product display into a three-dimensional map of the facility.

Furthermore, the computer system can leverage the three-dimensional image—of this three-dimensional product display—to predict a stock condition of product units of the first product type in the first product display. For example, the computer system can: estimate a volume of the display based on features extracted from the three-dimensional map; and, based on the volume, estimate a quantity of product units of the first product type present in the display depicted in the three-dimensional map. The computer system can then annotate the three-dimensional map with the quantity of product units of the first product type accordingly.

### 8.2 Feature Extraction: Product Detection & Stock Conditions

Block S120 of the method S100 recites: detecting absence of the first product in the first slot based on absence of features analogous to the first set of template features in the second region of the first image.

In one implementation, the computer system implements methods and techniques described in U.S. patent application Ser. No. 17/169,326 to extract features from the photographic image and based on these features: detects discrete shelf faces, shelves, and slots in the photographic image; detects product units occupying one slot in the photographic image; and interprets stock condition data (e.g., locations, orientations, product types, and quantities of these product units) of the facility. The computer system then annotates the three-dimensional map of the facility with these stock condition data, as further described below.

In one variation, the computer system scans laterally across a first shelf face region—extracted from the image—for a barcode. Upon detecting a barcode in this first shelf face region, the computer system: decodes the barcode for a product identifier; queries a product database for product data (e.g., a SKU value, a product description, and current product pricing) linked to this product identifier; reads a slot address directly from the first shelf label containing this barcode or by querying an inventory database for a slot address linked to this barcode; reads a price value from the first shelf face region; and annotates the three-dimensional map of the facility with a virtual identifier linked to these product data, slot address, and price value for this slot.

### 8.3 Virtual Identifier+Product Data

In one implementation, the computer system: scans a shelf face region in the image for a shelf tag or an electronic shelf label; extracts a shelf address from this shelf tag or electronic shelf label; and annotates the three-dimensional map of the facility and/or the image with the shelf address. Further, the computer system processes images recorded by the mobile robotic system: to extract slot, shelving segment, shelving structure, inventory structure, and/or aisle addresses from shelf tags or electronic shelf labels arranged on shelves, and aisle signs arranged on inventory structures, etc. depicted in these images; and to annotate the three-dimensional map of the facility with these addresses.

In one variation, the computer system: detects an address of a particular slot on a shelving structure in an image of a region of the facility; identifies a corresponding location within the three-dimensional map of the facility; and annotates the three-dimensional map in the corresponding location with a virtual identifier (e.g., a flag, a pin) linked to stock condition data associated with this slot.

For example, the computer system can: access an image, in a sequence of images, depicting an inventory structure within a region of the facility; detect a slot, in a set of slots in the inventory structure, depicted in the image; detect a shelf label, arranged below the slot, depicted in a first region of the image; extract a set of features from the first region; interpret product data (e.g., location, orientation, product type information, pricing information, quantity of a product unit information) based on the set of features; identify a region of the three-dimensional map of the facility depicting this slot in the inventory structure; annotate the region of the three-dimensional map with a flag linked to the product data for this slot; and render the three-dimensional map of the facility within a user portal. A user may then interface with the user portal: to review the three-dimensional map of the facility; to identify a region-of-interest representing the slot in the shelving structure within the three-dimensional map; and select the flag within the three-dimensional map to review the product data. Responsive to receiving selection of the flag, the computer system can serve the product data linked to the flag and associated with the slot to the user.

Therefore, the computer system can derive a three-dimensional map of the facility annotated with virtual identifiers linked to addresses and product data of slots, shelves, shelving segments, and inventory structures in the facility. The computer system can serve the three-dimensional map of the facility to the user portal and thereby, enable the user: to view the current state of shelves in the facility (e.g., with a latency of minutes or up to several hours since a last scan cycle at the facility); to virtually “walk through” a three-dimensional map of the interior environment of the facility; and to remotely monitor data (e.g., stock condition data, product data) associated with a region-of-interest within the facility.

### 9. Detection: Obstructions

In one variation, as shown in FIG. 2, the computer system can: leverage two-dimensional images (e.g., photographic images) and/or three-dimensional images of an inventory structure to detect presence of obstructions transiently located within regions of the facility, such as blocking a human walkway and/or access to product; and annotate three-dimensional representations of these regions with markers indicating presence of obstructions accordingly.

In particular, the computer system can: detect an obstruction in a first aisle in a three-dimensional representation of the first aisle; identify an obstruction type (e.g., human traffic, a food or water spill, a shopping cart) of the obstruction based on features extracted from a region of the three-dimensional representation including the obstruction; and annotate the three-dimensional representation of the first aisle with a marker—representing the obstruction type of the obstruction—in the region including the obstruction. The computer system can then present this three-dimensional representation of the first aisle—annotated with the marker indicating presence of the obstruction of the obstruction type—to the associate within the associate portal, such as individually and/or within a three-dimensional map of the facility.

For example, the computer system can detect an abandoned shopping cart remaining within a first aisle interposed between a first and second inventory structure. The computer system can then: flag a location of the abandoned shopping cart within the first aisle in a three-dimensional map of the facility, such as by annotating this location with an icon indicative of presence of a shopping cart; and present the three-dimensional map of the facility to the associate. Therefore, the associate may rapidly identify the icon—indicative of presence of the shopping cart—within the three-dimensional map and remove the shopping cart from the aisle and/or direct a facility associate to remove the shopping cart accordingly.

Therefore, in this variation, the computer system can annotate a three-dimensional map of the facility with a set of markers indicating obstructions and/or other unintentional objects located in the facility. Furthermore, the computer system can automatically generate a virtual walkthrough depicting a route through the facility to investigate and/or remove these objects from walkways, aisles, etc. The computer system can thus serve this three-dimensional map and/or virtual walkthrough to a store associate for investigation of these objects accordingly.

### 9.1 Detection: Infrastructure

Additionally or alternatively, in one variation, the computer system can: leverage two-dimensional images (e.g., photographic images) and/or three-dimensional images of an inventory structure to detect presence of infrastructure units located within regions of the facility; and annotate three-dimensional representations of these regions with markers indicating presence and/or detected characteristics of these infrastructure units accordingly.

In particular, the computer system can: detect an infrastructure unit—such as a light fixture, a refrigeration unit, a produce bin, signage, etc.—in a two- or three-dimensional image of a region of the facility including the infrastructure unit; extract a set of features from the image corresponding to the infrastructure unit; and, based on the set of features, derive a set of characteristics—such as representing a functionality, a location, an accessibility, etc.—of the infrastructure unit. The computer system can then annotate a three-dimensional image or representation of the region of the facility with this set of characteristics—such as by overlaying the infrastructure unit with the set of characteristics in the three-dimensional image or by linking the set of characteristics to the infrastructure unit—for review by the associate (e.g., within the associate portal).

For example, as shown in FIG. 2, the computer system can: detect a first light fixture—in a set of light fixtures arranged throughout the facility—in a three-dimensional representation (or map) of an aisle; and annotate the three-dimensional map; characterize a first color value of the first light fixture in the three-dimensional representation; access a nominal color value defined for the first fixture type at the facility; and characterize a difference between the first color value and the nominal color value. Then, in response to the difference exceeding a threshold difference, the computer system can: flag the first light fixture for maintenance; and annotate the three-dimensional representation of the aisle with a flag marker indicative of required maintenance at the first light fixture. The computer system can then repeat this process for each other light fixture, in the set of light fixtures, to identify a subset of light fixtures requiring maintenance and annotate the three-dimensional map of the facility accordingly.

Additionally or alternatively, in another example, the computer system can annotate the three-dimensional map of the facility with markers indicating locations of: the set of light fixtures arranged throughout the facility; a set of refrigeration units and product types of product units contained within the set of refrigeration units; a set of routers for wireless connectivity; a set of signage; a set of produce bins and product types of product units loaded within the set of produce bins; a set of inventory structures and product types of product units arranged within the set of inventory structures; etc. Furthermore, in this example, the computer system can annotate the three-dimensional map of the facility with markers indicating: which light fixtures, in the set of light fixtures, require maintenance; which refrigeration units, in the set of refrigeration units, require maintenance; etc.

### 9.1 Quality Check

In one variation, as shown in FIG. 2, the computer system can characterize a quality of a region of the facility based on characteristics extracted from three-dimensional images or representations of this region of the facility.

For example, the computer system can characterize an aisle of the store as “messy,” “organized,” or “understocked” based on conditions derived from images of the aisle. The computer system can then annotate the aisle with this quality in the three-dimensional representation or map of the aisle. Therefore, an associate viewing the three-dimensional representation or map may quickly derive insights into a quality (or “state”) of the aisle without requiring high-resolution review of the aisle within the map.

In particular, in this variation, the computer system can: characterize a quality of the aisle based on features extracted from the three-dimensional representation of the aisle; access a nominal quantity defined for the aisle; and, in response to the quality deviating from the nominal quality defined for the aisle, flag the aisle for inspection by a facility associate and annotate the three-dimensional representation of the aisle with a flag marker indicative of required inspection of the aisle.

### 10. Next Scan Cycle: Image Filtering+Three-Dimensional Map Update

Generally, the computer system (or the mobile robotic system) can: access a sequence of images depicting an inventory structure, captured by the mobile robotic system during a next scan cycle, from the remote database; access a set of priorities for the three-dimensional map of the facility (e.g., a product type priority, an inventory structure priority) defined by a user; filter the sequence of images to remove clusters of pixels depicting humans; and update the composite image, depicting the inventory structure, according to data contained in remaining pixels in the sequence of images.

More specifically, the computer system can: update composite images of the facility depicting only the floorplan (e.g., a floor, a set of walls, a ceiling, a set of aisles), inventory structures (e.g., a shelving structure, an end-cap, a top-shelf, a refrigeration unit), and non-human object types (e.g., caution signs, paper advertisements, promotional signs) according to the set of priorities; and assemble with a corresponding sequence of depth images to generate a current three-dimensional map of the facility.

In one implementation, the computer system: accesses a composite image of an inventory structure in a region of the facility captured by the mobile robotic system during a next scan cycle; identifies object types within the image; removes or discards clusters of pixels depicting a human object type from the image; and characterizes a dimension (e.g., a size, a width, a height, a quantity of absent pixels) of a hole in the composite image, corresponding to a discarded cluster of pixels, based on the remaining pixels of the image. Responsive to the dimension exceeding a target dimension, the computer system can update the composite image, depicting the inventory structure, according to data contained in remaining pixels in the composite image.

Alternatively, responsive to the dimension falling below the target dimension, the computer system can: retrieve a last stored image of the inventory structure in this region of the facility previously captured by the mobile robotic system; extract a cluster of pixels, approximating (e.g., matching, analogous to) the discarded cluster of pixels in the current composite image, from the last stored image; project the cluster of pixels onto the composite image of the inventory structure to fill the hole; detect a set of slots depicted in the composite image of the inventory structure; extract a set of features representing a set of product units in each slot from the composite image; derive a stock condition of each slot based on the set of features; calculate a score of the stock condition in a slot inversely proportional to an age of the set of features and inversely proportional to a value of the set of product units in the slot; and convert the score of the stock condition into a color value.

The computer system can further: initialize a translucent heatmap layer representing the inventory structure; assign a first color value to pixels corresponding to pixels from the current composite image to indicate a current data age of these pixels; assign a second color value to pixels corresponding to the cluster of pixels extracted from the last stored image to indicate a past data age of these pixels; and superimpose the translucent heatmap layer onto the composite image of the inventory structure to generate a data age heatmap representing a current data age and a past data age for this region of the facility.

In another implementation, the computer system: accesses a sequence of images depicting a region of the facility, captured by the mobile robotic system during a next scan cycle, from the remote database; filters the sequence of images to remove clusters of pixels depicting humans; interpolates a set of empty subregions between successive images in the sequence of images based on analogous features detected in successive images; initializes a visualization layer in the three-dimensional map of the facility; stitches the sequence of images into a composite image of this region of the facility; and populates the visualization layer with the composite image and depth images to generate a current three-dimensional map of the facility.

### 10.1 Prioritization+Time Windows

In one implementation, during a setup period, a user (e.g., a store manager, a store associate) may define a priority for inventory structures in the facility associated with a particular product type (e.g., fresh produce) and assign a particular time window and/or a frequency for image capture by the mobile robotic system.

In one variation, the user may define a particular time window to prevent image capture by the mobile robotic system—such as during high-traffic periods in the facility—to reduce human presence depicted in images. For example, a regional manager may interface with a user portal to define a time window for image capture exclusion such as a high-traffic period (e.g., 5-7:30 PM on weekdays and noon-7:00 PM on weekends in a grocery store). The computer system can then dynamically generate a path through the facility during a scan cycle to minimize human presence recorded by the mobile robotic system per unit time according to this high-traffic period.

In another variation, the user may define a set of priorities (e.g., a product type priority, an inventory structure priority, a privacy priority) of interest to the user for the three-dimensional map of the facility. The computer system then: interfaces with the user portal to receive this set of priorities; accesses a sequence of images recorded by the mobile robotic system during a next scan cycle; and processes this sequence of images to generate a three-dimensional map of the facility according to the set of priorities defined by the user.

For example, a regional store manager may: define a first priority specifying human absence for the three-dimensional map of the facility; define a second priority specifying complete images of product units (e.g., no partial images of product units in slots of an inventory structure, no partial shelf faces in a shelving structure); and define a third priority specifying current data (e.g., most recent images collected) for the facility. The computer system can then: access a sequence of images recorded by the mobile robotic system during a next scan cycle; and process this sequence of images to generate a three-dimensional map of the facility according to the set of priorities defined by the user.

Thus, the computer system can reduce the quantity of images offloaded by the mobile robotic system during a scan cycle and decrease the compute of the mobile robotic system to process these images (e.g., discard regions of images depicting humans), as further described below.

### 10.2 Image Filtering+Interpolation of Empty Subregions

Generally, the computer system can process a sequence of images captured by the mobile robotic system to remove or discard clusters of pixels depicting a human object type from each image according to the set of priorities defined by the user. The computer system can then characterize a dimension of a hole (e.g., a size, a width, a height, a quantity of absent pixels) in each image, corresponding to a discarded cluster of pixels, in order to overlay each image onto the three-dimensional map of the facility.

More specifically, the computer system can: access a first image depicting a first segment of an inventory structure in the facility and captured by the mobile robotic system; detect a human depicted in a first cluster of pixels, in a set of pixels, of a first image; and, in response to detecting the human in the first cluster of pixels of the first image, discard the first cluster of pixels from the first image. The computer system can then: access a second image depicting the first segment and a second segment of the inventory structure in the facility; based on features detected in the first image and the second image, interpolate a first subcluster of pixels representing a product unit in the first segment of the inventory structure within an empty subcluster of pixels, in the first cluster of pixels, of the first image; generate a reconstructed image, representing the product unit in the first segment of the inventory structure, based on the first image and the first subcluster of pixels; and project the reconstructed image and the second image onto the three-dimensional representation of the facility to form a visualization layer representing stock on the inventory structure.

In one implementation, the computer system: accesses an image of an inventory structure in a region of the facility captured by the mobile robotic system during a next scan cycle; extracts stock conditions and product data (e.g., positions, orientations, and quantities of products on shelves in the facility) from this image; identifies object types within the image; detects a cluster of pixels depicting a human object type; discards the cluster of pixels depicting the human object type from the image; and characterizes a dimension of a hole in the image, corresponding to the discarded cluster of pixels, based on the remaining pixels of the image. Responsive to the dimension exceeding a target dimension, the computer system: assigns a color value—such as a RGB color value (e.g., 0, 101, 255) or a hex color code (e.g., #0165fc) including a color intensity level of pixels (e.g., dull, light, medium, bright) within a color range (e.g., red, green, blue, black, white)—to each remaining pixel in the image; and updates the three-dimensional map of the facility with data, contained in remaining pixels of the image, to generate a current data age layer for this region of the facility within the three-dimensional map.

In one variation, the computer system: detects a cluster of pixels depicting a human within an image; redacts this cluster of pixels from the image; and characterizes a dimension of a hole in the image—such as a size of the hole, a width of the hole, a height of the hole, or a quantity of absent pixels in the image—based on the remaining pixels in the image. Responsive to the dimension exceeding a target dimension, the computer system stitches the sequence of images into a composite image of this region of the facility and overlays the composite image of this region of the facility onto the three-dimensional map of the facility.

In another implementation, upon removal of the cluster of pixels depicting humans from an image in a sequence of images, the computer system implements artificial intelligence, machine learning, and/or other computer vision techniques to interpolate an empty subregion in the image based on analogous features in successive images. In particular, the computer system can calculate an overlap score between a set of successive images in the sequence of images. Responsive to the overlap score exceeding a threshold overlap score, the computer system can: interpolate an empty subregion (e.g., the discarded cluster of pixels) in the current image based on analogous features in a next successive image in the sequence of images in order to reconstruct the current image of a region of the facility without human presence. The computer system can then: initialize a visualization layer in the three-dimensional map of the facility; stitch the sequence of images into a composite image of this region of the facility; and populate the visualization layer with the composite image and depth images to generate a current three-dimensional map of the facility.

For example, the computer system can: access a sequence of images depicting a shelving structure within the facility; detect a cluster of pixels depicting a human within a subregion of the first image; remove this cluster of pixels from the first image; calculate an overlap score between the first image and a second image in the sequence of images; and, in response to the overlap score exceeding a threshold overlap score, interpolate the empty subregion in the first image based on analogous features in a subregion of the second image to reconstruct the first image of the shelving structure without human presence. The computer system can then assign a color value, such as a green color range, a dull color intensity, and a RGB (0,128,0) value to each remaining pixel in the image; overlay the image onto the three-dimensional map of the facility to generate a current data age layer for this region of the facility within the three-dimensional map; and serve the three-dimensional map of the facility to the user portal.

Therefore, the computer system can address privacy concerns related to the deployment of the mobile robotic system or fixed optical sensors within the facility and reduce the possibility of accessing or recovering images depicting characteristics of humans by deleting clusters of pixels depicting humans from images.

### 10.3 Image Reconstruction: Human Presence+Stored Image Replacement

In one implementation, the computer system replaces an empty subcluster of pixels (i.e., a hole), representing partial features of a product unit on the inventory structure, in a current image with a corresponding cluster of pixels from a stored image in the remote database.

In particular, the computer system can characterize a dimension of a hole in the three-dimensional map and responsive to the dimension falling below a target dimension for images: retrieve a last stored image of the inventory structure in this region of the facility previously captured by the mobile robotic system; extract a corresponding cluster of pixels, cospatial with the hole, form the last stored image; project this cluster of pixels onto the hole within the three-dimensional map; update the three-dimensional map with stock condition data associated with the last stored image; assign a color value (e.g., dull red) to each remaining pixel in the image representing a data age of this image; and populate the three-dimensional map with this color value to generate a heatmap representing a current data age layer for this region of the facility.

In one variation, the computer system: accesses an image depicting a segment segment of an inventory structure in the facility and captured by the mobile robotic system; detects a human depicted in a cluster of pixels, in a set of pixels, of the image; and, in response to detecting the human in the cluster of pixels of the image, discards the cluster of pixels from the image.

The computer system then: characterizes a size of the hole in the image based on the set of pixels, excluding the cluster of pixels, of the image; and, in response to the size of the hole falling below a target size, accesses a stored image depicting the segment of the inventory structure from the remote database. The computer system further: extracts a subcluster of pixels representing a product unit in the segment of the inventory structure from the stored image and corresponding to an empty subcluster of pixels, in the first cluster of pixels, of the image; generates a reconstructed image, representing the product unit in the segment of the inventory structure, based on the image and the first subcluster of pixels; projects the reconstructed image onto the three-dimensional representation of the facility to form a visualization layer representing stock in the first segment of the inventory structure; and serves the three-dimensional representation to the user portal.

Therefore, the computer system can reconstruct a discarded cluster of pixels of an image with a corresponding cluster of pixels in a stored image of this region of the facility to prevent partial features of stock (e.g., packaged goods, product units) on the shelves of inventory structures within the three-dimensional representation of the facility and thereby, enable a user to view the three-dimensional representation of the facility during a past time period and/or a current time period.

### 10.4 Image Reconstruction: Template Image Replacement

In one implementation, the computer system replaces an empty subcluster of pixels, representing partial features of a product unit on the inventory structure, in a current image with a corresponding cluster of pixels from a template image in a template image database representing stock images of product units.

In one variation, the computer system: detects absence of a last stored image of the inventory structure in this region of the facility within the remote database; and, in response to detecting absence of the last stored image, accesses the template image database representing stock images of product units. The computer system then: scans the template image database for a template image depicting the current product unit; retrieves a template image of the current product unit from the template image database; skews the stock image (e.g., apply a horizontal slant to an image, apply a vertical slant to an image) and scales the stock image (e.g., resize the image by increasing the pixel information of the image, resize the image by decreasing the pixel information of the image) to match with the scale of the current image and to align with remaining pixels representing the partial product unit in the current image.

The computer system further: stitches the stock image with the current image to generate a reconstructed image depicting all features of the product unit; assigns a color value to pixels from the current image representing a current data age of the inventory structure; assigns a next color value, different from the previous color value, to pixels from the stock image to indicate a virtual representation of the product unit; projects the reconstructed image onto the three-dimensional representation of the facility to form a visualization layer representing stock on the inventory structure; populates the visualization layer with the first color value and the second color value to indicate the data age of pixels in the visualization layer; and serves the three-dimensional representation to the user portal.

Alternatively, the computer system can: append the three-dimensional map of the facility with the current image; retrieve a template image of the current product unit from the template image database; skew the stock image (e.g., apply a horizontal slant to an image, apply a vertical slant to an image) and scale the stock image (e.g., resize the image by increasing the pixel information of the image, resize the image by decreasing the pixel information of the image) to match with the scale of the three-dimensional map; and align with remaining pixels representing the partial product unit in the three-dimensional map.

Therefore, the computer system can reconstruct a discarded cluster of pixels of an image with a corresponding cluster of pixels in a template image of a product unit to prevent partial features of the product unit on a shelf of the inventory structure within the three-dimensional representation of the facility. Additionally, the computer system can populate a visualization layer with color values to indicate a data age of pixels within the three-dimensional representation of the facility.

### 11. Variation: Third-Party Shopper

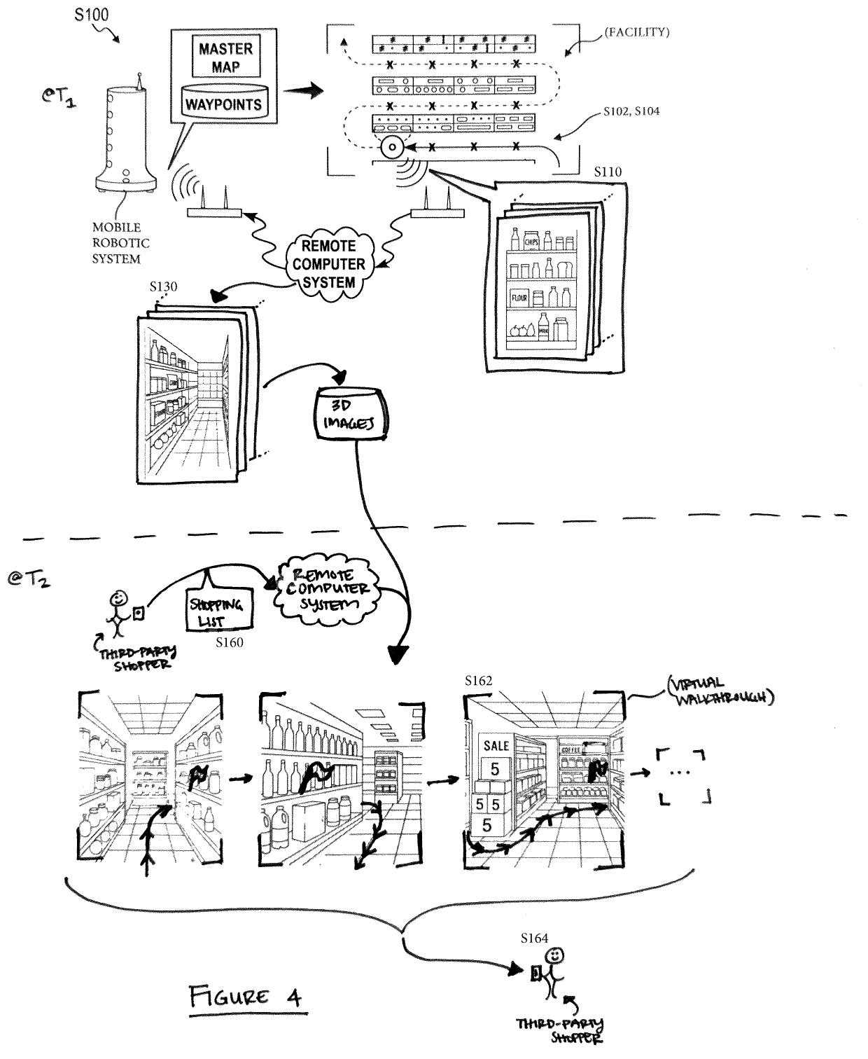

In one variation, as shown in FIG. 4, Blocks of the method S100 recite: via a shopper portal executing on a computing device accessed by a third-party user, receiving a request defining a shopping list including a first set of products of a first set of product types in Block S160; generating a virtual walkthrough depicting a route through the facility for collecting each product, in the first set of products in Block S162; and serving the virtual walkthrough to the third-party user via the shopper portal in Block S164.

Generally, in this variation, the computer system can interface with a shopper portal executing on a computing device (e.g., a smartphone, a tablet, a laptop, a desktop computer) accessed by a third-party shopper searching for a set of products—specified by a shopping request—within the facility.

Furthermore, the computer system can: generate a virtual walkthrough of a three-dimensional map for completion of the shopping request; and serve this virtual walkthrough to the third-party shopper via the shopper portal. Therefore, the third-party shopper may view the virtual walkthrough on their mobile device (e.g., a smartphone, a tablet) while completing the shopping request and navigating throughout the facility.

In particular, in this variation, the computer system can receive a request defining a shopping list—including a first set of products of a first set of product types—via a shopper portal executing on a computing device accessed by a third-party user. Then, for each product, in the first set of products, the computer system can: identify a location of the product within the facility, the location characterized by a particular inventory structure and a particular slot within the particular inventory structure; access the three-dimensional map of the facility; and annotate the three-dimensional map of the facility with a product marker, in a set of product markers, indicating the location of the product within the facility. The computer system can then: generate a virtual walkthrough depicting a route through the facility for collecting each product, in the first set of products, based on the three-dimensional map and the set of product markers; and serve the virtual walkthrough to the third-party user via the shopper portal.

Therefore, the computer system can enable the third-party shopper to preview their route throughout the facility and thus complete the shopping request more quickly. Furthermore, the computer system can alert the third-party shopper of out-of-stock products in advance and modify the route throughout the facility accordingly.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for visualizing an interior environment within a facility comprising:
by a mobile robotic system:
autonomously navigating along inventory structures within the facility; and
during an initial scan cycle, capturing images of inventory structures within a facility via an optical sensor arranged in the mobile robotic system; and
by a computer system:
accessing a first sequence of images of a first inventory structure, the first sequence of images captured by the mobile robotic system at a first time during the initial scan cycle;
identifying a first tag, arranged on the first inventory structure, depicted in a first region of a first image in the first sequence of images;
detecting a first set of features in the first region of the first image, the first set of features representing a first product descriptor;
retrieving a first set of template features of a first product type associated with the first product descriptor from a database of template features;
identifying a first slot, proximal the first tag, depicted in a second region of the first image;
detecting absence of product units of the first product type in the first slot based on absence of features analogous to the first set of template features in the second region of the first image;
constructing a three-dimensional image of the first inventory structure based on the first sequence of images;
annotating the three-dimensional image with a first marker representing absence of product units of the first product type in the first slot; and
serving the three-dimensional image of the first inventory structure to a portal executing on a computing device accessed by an associate affiliated with the facility.

2. The method of claim 1:
wherein accessing the first sequence of images of the first inventory structure comprises accessing the first sequence of images of the first inventory structure in a first aisle of the facility, the first aisle bounded by the first inventory structure and a second inventory structure; and
further comprising, by the computer system:
accessing a second sequence of images of the second inventory structure, the second sequence of images captured by the mobile robotic system at a second time during the initial scan cycle;
identifying a second tag, arranged on the second inventory structure, depicted in a third region of a second image in the second sequence of images;
detecting a second set of features in the third region of the second image, the second set of features representing a second product descriptor;
retrieving a second set of template features of a second product type associated with the second product descriptor from the database of template features;
identifying a second slot, proximal the second tag, depicted in a fourth region of the second image;
detecting absence of product units of the second product type in the second slot based on absence of features analogous to the second set of template features in the fourth region of the second image;
constructing a second three-dimensional image of the second inventory structure based on the second sequence of images;
annotating the second three-dimensional image of the second inventory structure with a second marker representing absence of product units of the second product type in the second slot;
combining the three-dimensional image of the first inventory structure with the second three-dimensional image of the second inventory structure to generate a three-dimensional representation of the first aisle; and
serving the three-dimensional representation of the first aisle to the portal accessed by the associate.

3. The method of claim 2, further comprising:
generating a three-dimensional walkthrough of the first aisle based on the three-dimensional representation of the first aisle; and
serving the three-dimensional walkthrough of the first aisle to the portal accessed by the associate for virtual navigation of the first aisle by the associate.

4. The method of claim 2:
further comprising:
detecting an obstruction in the first aisle in the three-dimensional representation of the first aisle;
identifying an obstruction type of the obstruction based on features extracted from a region of the three-dimensional representation comprising the obstruction; and
annotating the three-dimensional representation of the first aisle with a third marker, representing the obstruction type of the obstruction, in the region comprising the obstruction; and
wherein serving the three-dimensional representation of the first aisle to the portal comprises serving the three-dimensional representation of the first aisle to the portal, the three-dimensional representation annotated with the first marker, the second marker, and the third marker.

5. The method of claim 4, wherein identifying the obstruction type of the obstruction based on features extracted from the region of the three-dimensional representation comprises identifying the obstruction type of the obstruction based on features extracted from the region of the three-dimensional representation, the obstruction type comprising a shopping cart.

6. The method of claim 2, further comprising:
characterizing a quality of the first aisle based on features extracted from the three-dimensional representation of the first aisle;
accessing a nominal quantity defined for the first aisle; and
in response to the quality deviating from the nominal quality defined for the first aisle:
flagging the first aisle for inspection by a facility associate; and
annotating the three-dimensional representation of the first aisle with a flag marker indicative of required inspection of the first aisle.

7. The method of claim 2, further comprising:
detecting a first light fixture of a first fixture type in the three-dimensional representation of the first aisle;
characterizing a first color value of the first light fixture in the three-dimensional representation;
accessing a nominal color value defined for the first fixture type at the facility;
characterizing a difference between the first color value and the nominal color value; and
in response to the difference exceeding a threshold difference:
flagging the first light fixture for maintenance; and
annotating the three-dimensional representation of the aisle with a flag marker indicative of required maintenance at the first light fixture.

8. The method of claim 2, further comprising:
accessing a third sequence of images of a third inventory structure captured by the mobile robotic system during the initial scan cycle, the third inventory structure in a second aisle bounded by the third inventory structure and a fourth inventory structure;
constructing a third three-dimensional image of the third inventory structure based on the third sequence of images;
accessing a fourth sequence of images of the fourth inventory structure captured by the mobile robotic system during the initial scan cycle;
constructing a fourth three-dimensional image of the fourth inventory structure based on the fourth sequence of images;
combining the third three-dimensional image of the third inventory structure with the fourth three-dimensional image of the fourth inventory structure to generate a second three-dimensional representation of the second aisle;
combining the three-dimensional representation of the first aisle with the second three-dimensional representation of the second aisle to generate a three-dimensional map of the facility, the three-dimensional map annotated with markers representing stock conditions of products in slots in inventory structures throughout the facility; and
serving the three-dimensional map of the facility to the portal accessed by the associate.

9. The method of claim 8, further comprising:
generating a three-dimensional walkthrough of the facility based on the three-dimensional map of the facility; and
serving the three-dimensional walkthrough of the facility to the portal accessed by the associate for virtual navigation of the facility by the associate.

10. The method of claim 8, further comprising:
via a shopper portal executing on a computing device accessed by a third-party user, receiving a request defining a shopping list comprising a first set of products of a first set of product types;
for each product in the first set of products:
identifying a location of the product within the facility, the location characterized by a particular inventory structure and a particular slot within the particular inventory structure;
accessing the three-dimensional map of the facility; and
annotating the three-dimensional map of the facility with a product marker, in a set of product markers, indicating the location of the product within the facility;
generating a virtual walkthrough depicting a route through the facility for collecting each product, in the first set of products, based on the three-dimensional map and the set of product markers; and
serving the virtual walkthrough to the third-party user via the shopper portal.

11. The method of claim 8, further comprising:
detecting a display of product units of a first product type installed in a first location in the facility in the three-dimensional map of the facility;
estimating a volume of the display based on features extracted from the three-dimensional map;
based on the volume, estimating a quantity of product units of the first product type present in the display depicted in the three-dimensional map; and
annotating the three-dimensional map with the quantity of product units of the first product type.

12. The method of claim 1, wherein autonomously navigating along inventory structures within the facility by the mobile robotic system comprises autonomously navigating along inventory structures within the facility by the mobile robotic system comprising:
a base;
a drive system arranged in the base;
a power supply;
a set of mapping sensors;
a processor configured to transform data collected by the set of mapping sensors into maps of a space surrounding the robotic system;
a mast extending vertically from the base;
a set of cameras arranged on the mast; and
a wireless communication module configured to:
download waypoints and a master map of the facility from the computer system;
upload images captured by the set of cameras to the computer system; and
upload maps generated by the processor to the computer system.

13. The method of claim 1, further comprising:
for each slot, in a set of slots, depicted in the first image:
extracting a set of features representing a set of product units in the slot from the first image;
deriving a stock condition of the slot based on the set of features;
calculating a score of the stock condition in the slot inversely proportional to an age of the set of features and inversely proportional to a value of the set of product units in the slot; and
converting the score of the stock condition into a color value;
initializing a translucent heatmap layer representing the first inventory structure;
assigning a set of pixels in the translucent heatmap layer with corresponding color values of the set of slots; and
superimposing the translucent heatmap layer onto the three-dimensional image of the first inventory structure.

14. The method of claim 1, further comprising, by the computer system, during a second time period succeeding the first time period:
accessing a second sequence of images of the first inventory structure, the second sequence of images captured by the mobile robotic system at a second time during a second scan cycle succeeding the initial scan cycle;
detecting a human depicted in a first cluster of pixels, in a set of pixels, in a second image in the second sequence of images;
in response to detecting the human in the first cluster of pixels, discarding the first cluster of pixels from the second image; and
updating the three-dimensional image of the first inventory structure according to data extracted from the set of pixels, excluding the first cluster of pixels, in the second image.

15. The method of claim 1:
further comprising accessing a set of properties of a set of cameras integrated in the mobile robotic system;
wherein accessing the first sequence of images of the first inventory structure comprises accessing a first sequence of two-dimensional images captured by the set of cameras integrated in the mobile robotic system;
wherein identifying the first tag depicted in the first region of the first image comprises identifying the first tag depicted in the first region of a first two-dimensional image in the first sequence of two-dimensional images of the first inventory structure; and
wherein constructing the three-dimensional image of the first inventory structure based on the first sequence of images comprises constructing the three-dimensional image of the first inventory structure based on the first sequence of two-dimensional images and the set of properties of the set of cameras.

16. A method for visualizing an interior environment within a facility comprising:
by a mobile robotic system:
autonomously navigating along inventory structures within the facility; and
capturing images of inventory structures within a facility via an optical sensor arranged in the mobile robotic system; and
by a computer system:
accessing a first sequence of images of a first inventory structure, the first sequence of images captured by the mobile robotic system during a first scan cycle;
identifying a first set of slots in the first inventory structure based on features extracted from the first sequence of images;
detecting absence of product units of a first set of product types in a first subset of slots, in the first set of slots, based on absence of features analogous to template features defined for the first set of product types in the first sequence of images;
accessing a second sequence of images of a second inventory structure forming a first aisle with the first inventory structure, the second sequence of images captured by the mobile robotic system during the first scan cycle;
identifying a second set of slots in the second inventory structure based on features extracted from the second sequence of images;
detecting absence of product units of a second set of product types in a second subset of slots, in the second set of slots, based on absence of features analogous to template features defined for the second set of product types in the second sequence of images;
constructing a first three-dimensional image of the first inventory structure based on the first sequence of images;
annotating the first three-dimensional image with a first set of markers representing absence of product units of the first set of product types in the first subset of slots;
constructing a second three-dimensional image of the second inventory structure based on the second sequence of images;
annotating the second three-dimensional image with a second set of markers representing absence of product units of the second set of product types in the second subset of slots; and
constructing a three-dimensional representation of the first aisle based on the first three-dimensional image and the second three-dimensional image.

17. The method of claim 16, further comprising serving the three-dimensional image of the first inventory structure to a portal executing on a computing device accessed by an associate affiliated with the facility.

18. The method of claim 16, further comprising:
accessing a third sequence of images of a third inventory structure, the third sequence of images captured by the mobile robotic system during the first scan cycle;
identifying a third set of slots in the third inventory structure based on features extracted from the third sequence of images;
detecting absence of product units of a third set of product types in a third subset of slots, in the third set of slots, based on absence of features analogous to template features defined for the third set of product types in the third sequence of images;
accessing a fourth sequence of images of a fourth inventory structure forming a second aisle with the third inventory structure, the fourth sequence of images captured by the mobile robotic system during the first scan cycle;
identifying a fourth set of slots in the fourth inventory structure based on features extracted from the fourth sequence of images;
detecting absence of product units of a fourth set of product types in a fourth subset of slots, in the fourth set of slots, based on absence of features analogous to template features defined for the fourth set of product types in the fourth sequence of images;
constructing a third three-dimensional image of the third inventory structure based on the third sequence of images;
annotating the third three-dimensional image with a third set of markers representing absence of product units of the third set of product types in the third subset of slots;
constructing a fourth three-dimensional image of the fourth inventory structure based on the fourth sequence of images;
annotating the fourth three-dimensional image with a fourth set of markers representing absence of product units of the fourth set of product types in the fourth subset of slots;
constructing a second three-dimensional representation of the second aisle based on the third three-dimensional image and the fourth three-dimensional image; and
combining the three-dimensional representation of the first aisle with the second three-dimensional representation of the second aisle to generate a three-dimensional map of the facility.

19. A method for visualizing an interior environment within a facility comprising:
by a robotic system:
autonomously navigating along inventory structures within the facility; and
capturing a first sequence of images of regions within a facility, within a field of view of an optical sensor arranged in the mobile robotic system, while occupying a first location within the facility at a first time; and
by a computer system:
accessing the first sequence of images captured by the mobile robotic system autonomously traversing the facility;
for each image in the first sequence of images:
extracting a set of features representing an inventory structure from the image;
detecting a set of product units on the inventory structure; and
for each product unit in the set of product units:
interpreting a product type, in a set of product types, of the product unit;
interpreting a location, in a set of locations, of the product unit; and
interpreting a stock condition, in a set of stock conditions, of the product unit;
assembling the first sequence of images into a three-dimensional representation of the inventory structure; and
annotating the three-dimensional representation of the inventory structure with the set of product types, the set of locations, and the set of stock conditions.

20. The method of claim 19, further comprising, by the computer system:
accessing a second sequence of images captured by the mobile robotic system autonomously traversing the facility;
for each image in the second sequence of images:
extracting a second set of features representing a second inventory structure from the image;
detecting a second set of product units on the second inventory structure; and
for each product unit in the second set of product units:
interpreting a product type, in a second set of product types, of the product unit;
interpreting a location, in a second set of locations, of the product unit; and
interpreting a stock condition, in a second set of stock conditions, of the product unit;
assembling the second sequence of images into a second three-dimensional representation of the inventory structure;
annotating the second three-dimensional representation of the second inventory structure with the second set of product types, the second set of locations, and the second set of stock conditions; and
assembling the three-dimensional representation of the first inventory structure and the second three-dimensional representation of the second inventory structure into a three-dimensional map of the facility.
